(19) United States
(12) Patent Application Publication
(10) Pub. No.: US 2008/0074547 A1
(43) Pub. Date: Mar. 27, 2008

(54) Video display system, and main apparatus and sub apparatus included in video display system

(75) Inventor: Tomotaka Ida, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/898,169

(22) Filed: Sep. 10, 2007

(30) Foreign Application Priority Data
Sep. 22, 2006 (JP) 2006-257657

(51) Int. Cl. H04N 3/27; H04N 5/268

(52) U.S. Cl. 348/554; 348/705

(57) ABSTRACT

According to one embodiment, a video display system receiving a broadcast video signal to perform display according to the video signal includes: a main apparatus including at least a display displaying video according to the video signal and a controller controlling an operation of the main apparatus; one or a plurality of sub apparatuses each including at least a tuner receiving a broadcast video signal and a controller controlling an operation of the sub apparatus by transmitting/receiving a control signal to/from the main apparatus; and a video signal line and a control signal line disposed between the main apparatus and the sub apparatus, the video signal line being for transmission of the video signal from the sub apparatus to the main apparatus and the control signal line being for transmission of the control signal between the main apparatus and the sub apparatus. The controller of the main apparatus transmits the control signal for inquiry of a type of the tuner of the sub apparatus to the sub apparatus via the control signal line, and the controller of the sub apparatus executes processing corresponding to the control signal when receiving the control signal from the main apparatus.

### CROSS-REFERENCE TO RELATED APPLICATIONS

This application is based upon and claims the benefit of priority from Japanese Patent Application No. 2006-257657, filed Sep. 22, 2006, the entire contents of which are incorporated herein by reference.

### BACKGROUND

1. Field

One embodiment of the invention relates to a video display system receiving a broadcast video signal to perform display according to the video signal.

2. Description of the Related Art

Conventionally, there has been known a video display system receiving a broadcast video signal to perform display according to the video signal. For example, such a video display system includes, as a major component, a television apparatus including a display and a tuner receiving terrestrial broadcasts, and is structured such that peripherals capable of receiving BS (Broadcasting Satellite) broadcasts, CS (Communication Satellite) broadcasts, and the like are connected to the television apparatus as desired by a user. A patent document 1 (Japanese Patent Application Publication (KOKAI) No. 2004-304220) discloses an example of a video display system in which peripherals are connected to a television apparatus.

As an interface standard for input/output of video signals, sound signals, and so on between a television apparatus and its peripherals in a video display system, there is a HDMI (High-Definition Multimedia Interface) standard. In this HDMI standard, a plurality of signal lines (a signal line for video signal transmission, a signal line for sound signal transmission, and a signal line for control signal transmission) are combined as a single cable, and thus cable wiring is facilitated. Further, control signals exchanged via a cable conforming to the HDMI standard is based on a control protocol called HDMI-CEC (Consumer Electronics Control). By the exchange of the control signals based on the HDMI-CEC between the television apparatus and the peripherals, linked operations of the television apparatus and the peripherals are realized.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a video display system according to an embodiment of the invention;

FIG. 2 is an exemplary block diagram showing a television apparatus in the embodiment;

FIG. 3 is an exemplary flowchart showing display change processing (processing by the television apparatus) when a broadcast type change key is pressed in the embodiment;

FIG. 4 is an exemplary sequence chart showing the display change processing when the broadcast type change key is pressed in the embodiment;

FIG. 5 is an exemplary flowchart showing display change processing (processing by the television apparatus) when a channel up key is pressed in the embodiment;

FIG. 6 is an exemplary sequence chart showing the display change processing when the channel up key is pressed in the embodiment;

FIG. 7 is an exemplary flowchart showing register processing for direct tuning in the embodiment;

FIG. 8 is an exemplary sequence chart showing register processing (1 key) for direct tuning in the embodiment;

FIG. 9 is an exemplary sequence chart showing register processing (2 key) for direct tuning in the embodiment;

FIG. 10 is an exemplary view showing a position table of a remote controller for the television apparatus in the embodiment;

FIG. 11 is an exemplary flowchart showing direct tuning processing (processing by the television apparatus) in the embodiment;

FIG. 12 is an exemplary flowchart showing direct tuning processing (processing by a peripheral) in the embodiment;

FIG. 13 is an exemplary sequence chart showing direct tuning processing (1 key) in the embodiment; and

FIG. 14 is an exemplary sequence chart showing direct tuning processing (2 key) in the embodiment.

### DETAILED DESCRIPTION

Various embodiments according to the invention will be described hereinafter with reference to the accompanying drawings. In general, according to one embodiment of the invention, a video display system receiving a broadcast video signal to perform display according to the video signal includes: a main apparatus including at least a display displaying video according to the video signal and a controller controlling an operation of the main apparatus; one or a plurality of sub apparatuses each including at least a tuner receiving a broadcast video signal and a controller controlling an operation of the sub apparatus by transmitting/receiving a control signal to/from the main apparatus; and a video signal line and a control signal line disposed between the main apparatus and the sub apparatus, the video signal line being for transmission of the video signal from the sub apparatus to the main apparatus and the control signal line being for transmission of the control signal between the main apparatus and the sub apparatus, wherein: the controller of the main apparatus transmits the control signal for inquiry of a type of the tuner of the sub apparatus, to the sub apparatus via the control signal line; and the controller of the sub apparatus executes processing corresponding to the control signal when receiving the control signal from the main apparatus.

### First Embodiment

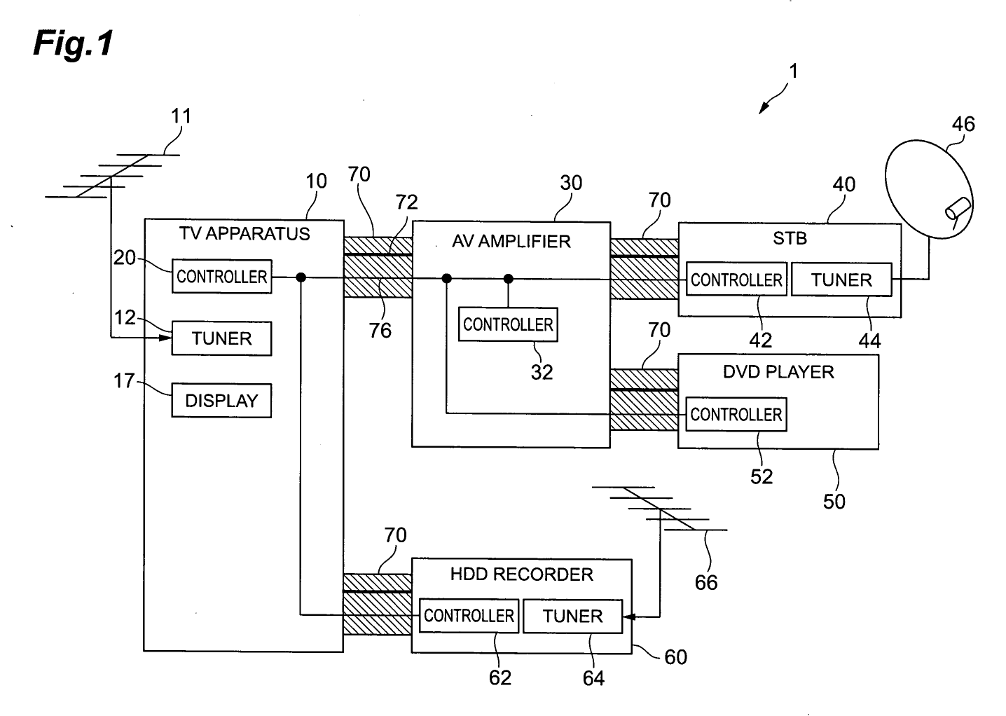

First, a video display system according to a first embodiment will be described. FIG. 1 schematically shows a video display system 1 displaying video. The video display system 1 includes a television apparatus 10, an AV amplifier 30, a set top box 40, a DVD player 50, and a HDD recorder 60. Among these AV apparatuses 10, 30, 40, 50, 60, cables (hereinafter, referred to as HDMI cables) 70 conforming to the HDMI (High-Definition Multimedia Interface) standard are disposed, and these AV apparatuses 10, 30, 40, 50, 60 are mutually connected via the HDMI cables 70. The television apparatus 10 is a main apparatus as a major component of the video display system 1. The AV amplifier 30, the set top box 40, the DVD player 50, and the HDD recorder 60 are sub apparatuses connected in the video display system 1 as desired by a user.

The television apparatus 10 includes a display 17 displaying video. The television apparatus 10 further includes an antenna 11 and a tuner 12 for receiving terrestrial digital broadcasts and has a function of receiving broadcast video signals and sound signals. The television apparatus 10 further includes a controller 20 centrally controlling the operation of the television apparatus 10. The controller 20 includes a CPU (Central Processing Unit) 21, a RAM (Random Access Memory) 23, a ROM (Read Only Memory) 22, and so on. The structure of the television apparatus 10 will be described in detail later.

The set top box 40 and the DVD player 50 are connected to the AV (Audio-Visual) amplifier 30 via the HDMI cables 70. The AV amplifier 30 acquires a video signal and a sound signal selectively from one of the set top box 40 and the DVD player 50 via the HDMI cable 71, and after processing the acquired video signal and sound signal, outputs the resultant signals to the television apparatus 10. Further, the AV amplifier 30 includes a controller 32 centrally controlling the operation of the AV amplifier 30. The controller 32 includes a CPU, a RAM, a ROM, and so on. In the ROM of the AV amplifier 30, information indicating that a tuner is not mounted in the AV amplifier 30 is stored.

The set top box 40 includes an antenna 46 and a tuner 44 for receiving BS (Broadcasting Satellites) broadcasts and has a function of receiving broadcast video signals and sound signals. The set top box 40 has a function of outputting the received video signals and sound signals to the AV amplifier 30 via the HDMI cable 70. The set top box 40 further includes a controller 42 centrally controlling the operation of the set top box 40. The controller 42 includes a CPU, a RAM, a ROM, and so on. In the ROM of the set top box 40, information indicating that the tuner 44 is mounted in the set top box 40 and information on the type (for Satellite broadcasting) of the tuner 44 mounted in the set top box 40 are stored.

The DVD (Digital Versatile Disc) player 50 has a function of reading video signals and sound signals from a DVD to output the read video signals and sound signals to the AV amplifier 30 via the HDMI cable 70. Further, the DVD player 50 includes a controller 52 centrally controlling the operation of the DVD player 50. The controller 52 includes a CPU, a RAM, a ROM, and so on. In the ROM of the DVD player 50, information indicating that a tuner is not mounted in the DVD player 50 is stored.

The HDD (Hard Disk Drive) recorder 60 includes an antenna 66 and a tuner 64 for receiving terrestrial analog broadcasts and has a function of receiving broadcast video signals and sound signals to write the received video signals and sound signals to a hard disk. The HDD recorder 60 further has a function of outputting the received video signals and sound signals to the television apparatus 10 via the HDMI cable 70. The HDD recorder 60 further includes a controller 62 centrally controlling the operation of the HDD recorder 60. The controller 62 includes a CPU, a RAM, a ROM, and so on. In the ROM of the HDD recorder 60, information indicating that the tuner 64 is mounted in the HDD recorder 60 and information on the type (for terrestrial analog broadcasting) of the tuner 64 mounted in the HDD recorder 60 are stored.

Each of the cables 70 conforming to the HDMI standard is a single cable in which a video/sound signal line 72 for transmission of video signals, sound signals, and so on, a control signal line 76 for transmission of control signals, and so on are combined. The control signal line 76 mutually connects the controller 20 of the television apparatus 10, the controller 32 of the AV amplifier 30, the controller 42 of the set top box 40, the controller 52 of the DVD player 50, and the controller 62 of the HDD recorder 60. The respective controllers 20, 32, 42, 52, 62 of the AV apparatuses 10, 30, 40, 50, 60 exchange control signals via the control signal lines 76. The control signals exchanged among the AV apparatuses are based on a control protocol called HDMI-CEC (Consumer Electronics Control). The control signals based on the HDMI-CEC are exchanged between the television apparatus 10 and the peripherals 30, 40, 50, 60, which realizes the linked operations of the television apparatus 10 and the peripherals 30, 40, 50, 60. Incidentally, the control signals exchanged among the AV apparatuses in this embodiment may be commands that are standard in the HDMI-CEC or may be vender commands arbitrarily set by manufacturers of the AV apparatuses.

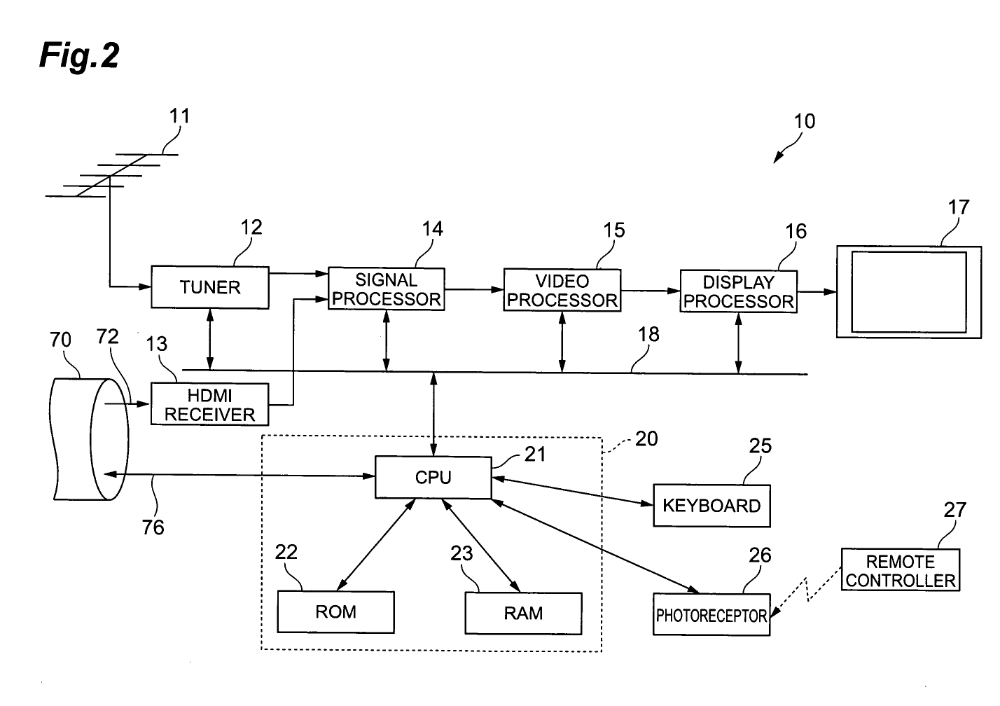

Next, the above-described television apparatus 10 will be described in more detail with reference to FIG. 2. FIG. 2 shows the internal structure of the above-described television apparatus 10.

The television apparatus 10 includes the antenna 11 and the tuner 12 as means for receiving the terrestrial digital broadcasts. Broadcast waves received by the antenna 11 are supplied to the tuner 12. The tuner 12 selectively receives broadcast signals with a desired frequency from the broadcast waves and demodulates the received broadcast signals to output the demodulated broadcast signals to a signal processor 14.

The television apparatus 10 further includes a HDMI receiver 13 as a means for receiving video signals and sound signals via the HDMI cable 70. The HDMI receiver 13 is connected to the HDMI cable 70 and receives incoming video signals and sound signals from external apparatuses (such as the set top box 40, the DVD player 50, the HDD recorder 60, and so on) via the HDMI cable 70 to output the received video signals and sound signals to the signal processor 14.

The television apparatus 10 further includes the signal processor 14, a video processor 15, and a display processor 16 as means for enabling a display 17 to display video according to the video signals. The signal processor 14 separates video signals, sound signals, and other signals from the broadcast signals supplied from the tuner 12 and extracts desired signals from these plural signals. Then, the signal processor 14 outputs the extracted video signal to the video processor 15 and outputs the selected sound signal to a sound processor (not shown). Further, the signal processor 14 applies signal processing to the video signals and sound signals supplied from the HDMI receiver 13 to output the video signals having undergone the signal processing to the video processor 15 and output the sound signals having undergone the signal processing to the sound processor.

The video processor 15 performs processing for appropriately adjusting an angle of view, color, and the like of the video signal supplied from the signal processor 14 and outputs the adjusted video signal to the display processor 16. The display processor 16 converts the video signal supplied from the video processor 15 into a video signal in a format displayable on the display 17 and outputs the converted video signal to the display 17. Further, the display processor 16 generates image signals for an EPG (Electronic Program Guide), an OSD (On Screen Display), and so on and outputs the generated image signals for the electronic program guide and the OSD to the display 17 together with the video signal. The sound processor converts the inputted sound signal into a sound signal in a format reproducible by a speaker (not shown) and thereafter outputs the converted sound signal to the speaker.

As a means for centrally controlling the operation of the television apparatus 10, the television apparatus 10 further includes the controller 20 including the CPU 21, the RAM 23, and the ROM 22, as described above. The CPU 21 of the controller 20 is connected to a signal line 18 disposed in the television apparatus 10 and centrally controls the operation of the television apparatus 10 by sending a control signal to each part via the signal line 18. Further, the controller 20 receives an input originating from a user's operation of a keyboard 25 or a remote controller 27 to control each part according to the user's operation. When the user operates the remote controller 27, an infrared signal corresponding to the user's operation is transmitted from the remote controller 27 and the infrared signal is sensed by a photoreceptor 26. The remote controller 27 has a ten-key pad for input of numbers from 0 to 9, a channel up key and a channel down key for channel selection, a direction key for input of one of up, down, right, and left, a broadcast type change key for changing the type of a broadcast displayed on the display 17, and so on.

It should be noted that the above-described structure of the image display system 1 is only one example of the structure of the invention and the video display system may have a different structure. For example, in the above-described embodiment, the plural AV apparatuses 10, 30, 40, 50, 60 are mutually connected via the HDMI cables 70, but the plural AV apparatuses 10, 30, 40, 50, 60 may be mutually connected via cables of other kind such as IIC-BUS (Inter-IC-Bus) or UART (Universal Asynchronous Receiver Transmitter).

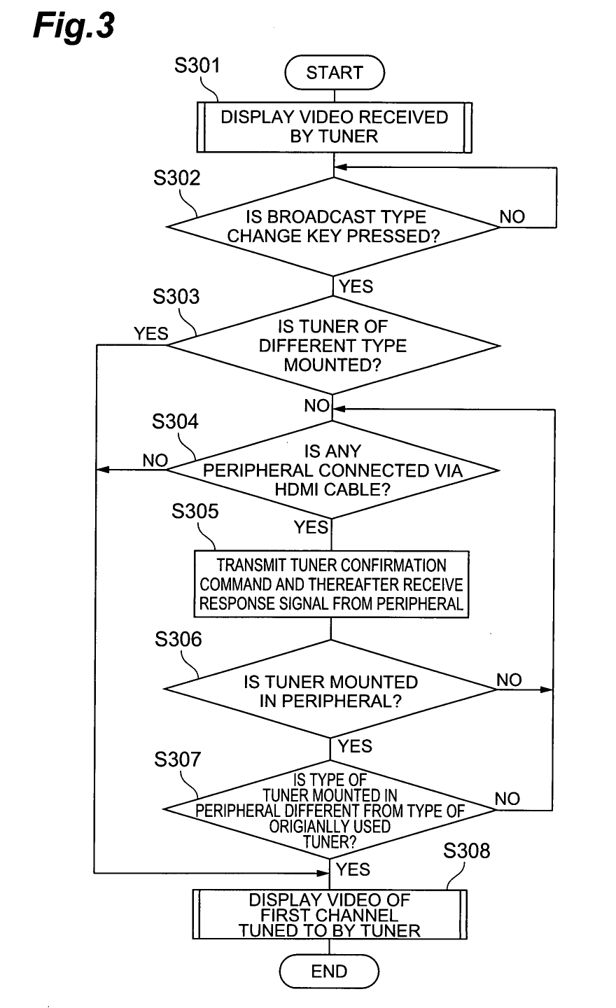

Next, first display change processing executed in the video display system 1 of this embodiment will be described. The first display change processing is executed when the broadcast type change key of the remote controller 27 for the television apparatus 10 is pressed by a user. FIG. 3 shows a flowchart of processes executed by the controller 20 of the television apparatus 10 in the first display change processing. The display change processing described here is realized by the controller 20 of the television apparatus 10 executing a program.

At S301, the controller 20 of the television apparatus 10 displays on the display 17 video received by the tuner 12, 44, or 64 mounted in the television apparatus 10 or the peripheral 40 or 60. For convenience of description, it is assumed in the following description that subsequent processes are executed in a state where video of a terrestrial digital broadcast received by the tuner 12 mounted in the television apparatus 10 is displayed on the display 17. However, the subsequent processes may be executed in a state where video received by either of the tuners 44, 64 of the peripherals 40, 60 is displayed on the display 17.

At S302, the controller 20 of the television apparatus 10 determines whether or not a tuner change condition under which a tuner change should be performed is satisfied. The tuner change condition here is a condition that “the broadcast type change key of the remote controller 27 is operated”. When determining at S302 that the tuner change condition is satisfied, the controller 20 of the television apparatus 10 proceeds to a process at S303. Incidentally, in this embodiment, the broadcast type change key for changing the broadcast type (terrestrial analog broadcasting, terrestrial digital broadcasting, Satellite broadcasting, and the like) is provided in the remote controller 27, but in a different embodiment, the broadcast change key may be displayed as an OSD on the display 17.

At S303, the controller 20 of the television apparatus 10 determines whether or not a tuner of a different type is mounted in the television apparatus 10 (the peripheral 40 or 60 if video received by the peripheral 40 or 60 is displayed at S301). When determining at S303 that a tuner of a different type is mounted in the television apparatus 10, the controller 20 of the television apparatus 10 proceeds to a process at S308, and performs control so that the first channel received by this tuner is tuned to and a video signal of the tuned channel is displayed on the display 17. On the other hand, when determining at S303 that a tuner of a different type is not mounted in the television apparatus 10, the controller 20 of the television apparatus 10 proceeds to a process at S304.

At S304, the controller 20 of the television apparatus 10 checks whether or not any peripheral is connected via the HDMI cable 70. The controller 20 of the television apparatus 10 is set to check the presence/absence of a peripheral and a physical address of the peripheral when the television apparatus 10 is activated, and stores information on the presence/absence and physical address of the peripheral after the television apparatus 10 is activated. Therefore, the controller 20 of the television apparatus 10 can check the presence/absence of the peripheral connected via the HDMI cable 70, based on the stored information on the presence/absence of the peripheral. When determining at S304 that no peripheral is connected, the controller 20 of the television apparatus 10 proceeds to the process at S308, and performs control so that the first channel received by the originally used tuner 12 mounted in the television apparatus 10 is tuned to and a video signal of the tuned channel is displayed on the display 17. When determining at S304 that there exists a connected peripheral, the controller 20 of the television apparatus 10 proceeds to a process at S305.

At S305, the controller 20 of the television apparatus 10 transmits to this peripheral a tuner confirmation command for checking whether or not a tuner is mounted in the peripheral. The tuner confirmation command is a control signal not only for inquiry of the presence/absence of a tuner but also for inquiry of a type of the tuner. When receiving the tuner confirmation command from the television apparatus 10, the peripheral reads, from the ROM, the information indicating the presence/absence of a tuner and the type of the tuner, and transmits a response signal including these pieces of information to notify the presence/absence of a tuner and the type of the tuner. The information indicating the type of the tuner is information indicating the type of a broadcast received by the tuner, such as, for example, a terrestrial analog broadcast, a terrestrial digital broadcast, a Satellite broadcast, or the like. At S305, when receiving the response signal transmitted from the peripheral, the controller 20 of the television apparatus 10 proceeds to a process at S306.

At S306, based on the response signal sent from the peripheral, the controller 20 of the television apparatus 10 determines whether or not a tuner is mounted in the peripheral. When determining at S306 that a tuner is not mounted in the peripheral, the controller 20 of the television apparatus 10 returns to the process at S304 to check whether or not any other peripheral is connected via the HDMI cable 70. On the other hand, when determining at S306 that a tuner is mounted in the peripheral, the controller 20 of the television apparatus 10 proceeds to a process at S307.

At S307, the controller 20 of the television apparatus 10 determines whether or not the tuner mounted in the peripheral is of a unique type. That is, the controller 20 of the television apparatus 10 determines whether or not the type of the tuner of the peripheral is different from the type of the tuner 12 of the television apparatus 10 (the television apparatus 10 and the peripheral 40 or 60 whose tuners have already been used for video display, if video received by the peripheral 40 or 60 is displayed at S301). When determining at S307 that the type of the tuner of the peripheral is different from the type of the tuner 12 of the television apparatus 10, the controller 20 of the television apparatus 10 proceeds to the process at S308, and performs control so that the first channel received by the tuner of the peripheral is tuned to and video of the tuned channel is displayed on the display 17. On the other hand, when determining at S307 that the type of the tuner of the peripheral is not different from the type of the tuner 12 of the television apparatus 10, the controller 20 of the television apparatus 10 returns to the process at S304 to check whether or not any another peripheral is connected via the HDMI cable 70.

According to the above-described first display change processing, when a user presses the broadcast type change key provided in the remote controller 27 for the television apparatus 10, video displayed on the display 17 of the television apparatus 10 is changed from video received by the tuner 12 of the television apparatus 10 to video received by the tuner 44 or 64 of the peripheral 40 or 60. To describe in more detail, by pressing the broadcast type change key, the user can change video displayed on the display 17 of the television apparatus 10 from video received by the tuner 12 of the television apparatus 10 to video received by the tuner 44 of the set top box 40. Further, by pressing the broadcast type change key again, the user can change video displayed on the display 17 of the television apparatus 10 from the video received by the tuner 44 of the set top box 40 to video received by the tuner 64 of the HDD recorder 60. Further, by pressing the broadcast type change key again, the user can change the video received by the tuner 64 of the HDD recorder 60 to the originally displayed video received by the tuner of the television apparatus 10

In particular, according to the above-described first display change processing, when video displayed on the display 17 of the television apparatus 10 is to be changed, it is determined whether or not the type of a tuner to be used next for video display is different from the type of a tuner already used for video display (S307), and only when it is determined that the types of the tuners are different, the video is changed. Therefore, the display 17 does not redundantly display video of the broadcast of the same type, which can make the video display system easier to handle for a user.

Incidentally, in the above-described first display change processing, it is also suitable to change the display based on a priority sequence given to each tuner type. For example, tuner change may be performed in order of 1. a tuner for terrestrial analog broadcasting, 2. a tuner for terrestrial digital broadcasting, and 3. a tuner for Satellite broadcasting, every time a user presses the broadcast type change key. Such display change processing can be realized by the controller 20 of the television apparatus 10 further determining at S307 whether or not the type of the tuner corresponds to the priority sequence. Executing such display change processing makes it possible to always display the videos on the display 17 in the same order, which can make the video display system easier to handle for a user.

In the above-described first display change processing, at the timing when the user presses the broadcast type change key, the controller 20 of the television apparatus 10 transmits the tuner confirmation command to the controller 32, 42, 52, or 62 of the peripheral 30, 40, 50, or 60 to inquire the presence/absence of a tuner and the type of the tuner. However, at another timing, the controller 20 of the television apparatus 10 may transmit the tuner confirmation command to the controllers 32, 42, 52, 62 of the peripherals 30, 40 50, 60 to inquire the presence/absence of a tuner and the type of the tuner. For example, at the activation timing of the television apparatus 10, the controller 20 of the television apparatus 10 may transmit the tuner confirmation command to the controllers 32, 42, 52, 62 of the peripherals 30, 40, 50, 60 to inquire the presence/absence of a tuner and the type of the tuner. By transmitting the tuner confirmation command at such a timing, it is possible to generate table data including information on the presence/absence of tuners and the type of the tuners in advance, so that the above-described display change processing can be executed speedily.

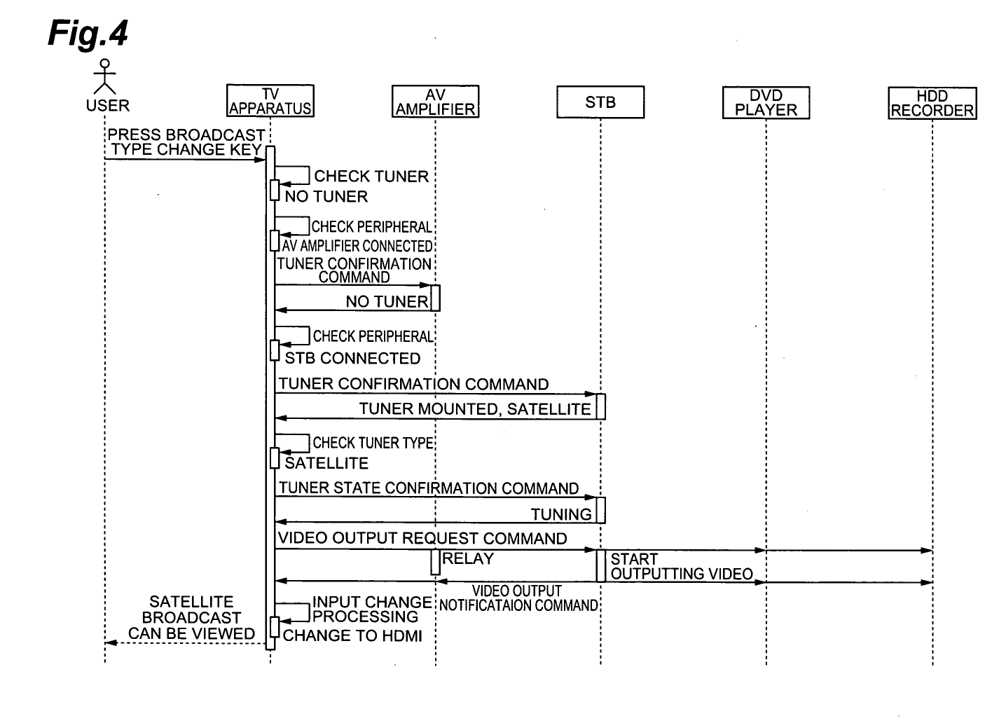

Next, the operations of the television apparatus 10 and its peripherals 30, 40, 50, 60 when the display change processing of this embodiment is executed will be described with reference to a sequence chart shown in FIG. 4. The sequence chart in FIG. 4 shows the operations of the television apparatus 10 and its peripherals 30, 40, 50, 60 together with control signals exchanged between the television apparatus 10 and its peripherals 30, 40, 50, 60.

When a user presses the broadcast type change key of the remote controller 27 for the television apparatus 10, the controller 20 of the television apparatus 10 recognizes that the broadcast type change key has been pressed by the user. Then, since the tuner change condition is satisfied, the controller 20 of the television apparatus 10 checks whether or not a tuner of a different type is mounted in the television apparatus 10. However, in this embodiment, since only the tuner 12 for terrestrial digital broadcasting is mounted in the television apparatus 10, the controller 20 of the television apparatus 10 recognizes that a tuner of a different type is not mounted.

Next, the controller 20 of the television apparatus 10 checks whether or not any peripheral is connected via the HDMI cable 70. In this embodiment, since the AV amplifier 30, the set top box 40, the DVD player 50, the HDD recorder 60, and so on are connected, the controller 20 of the television apparatus 10 first recognizes the presence of the AV amplifier 30 whose physical address is the smallest among these peripherals. Then, the controller 20 of the television apparatus 10 transmits a tuner confirmation command for confirming the presence/absence of a tuner and the type of the tuner, to the AV amplifier 30 via the control signal line 76. No tuner is mounted in the AV amplifier 30, and therefore, in response to the tuner confirmation command, the controller 32 of the AV amplifier 30 transmits a response signal indicating that no tuner is mounted, to the television apparatus 10 via the control signal line 76. When receiving the response signal, the controller 20 of the television apparatus 10 recognizes that no tuner is mounted in the AV amplifier 30.

Next, the controller 20 of the television apparatus 10 checks whether or not any other peripheral is connected via the HDMI cable 70. Secondly, the controller 20 of the television apparatus 10 confirms the presence of the set top box 40 whose physical address is the second smallest among the peripherals. Then, the controller 20 of the television apparatus 10 transmits a tuner confirmation command for confirming the presence/absence of a tuner and the type of the tuner, to the set top box 40 via the control signal line 76. The tuner 44 for Satellite broadcasting is mounted in the set top box 40, and therefore, in response the tuner confirmation command, the controller 42 of the set top box 40 transmits a response signal indicating that the tuner 44 for Satellite broadcasting is mounted, to the television apparatus 10 via the control signal line 76. The controller 20 of the television apparatus 10 checks the type of the tuner 44 mounted in the set top box 40, and recognizes that the tuner 44 for Satellite broadcasting is mounted in the set top box 40, based on the response signal sent from the set top box 40, and recognizes that video received by the tuner 44 for Satellite broadcasting has not been displayed yet.

Next, the controller 20 of the television apparatus 10 transmits a tuner state confirmation command for confirming the state of the tuner, to the set top box 40 via the control signal line 76. In response to the tuner state confirmation command, the controller 42 of the set top box 40 transmits a response signal notifying that the tuner 44 mounted in the set top box 40 is in the course of tuning, to the television apparatus 10 via the control signal line 76.

Next, the controller 20 of the television apparatus 10 transmits a video output request command requesting the output of video, to the set top box 40 via the control signal line 76. In response to the video output request command, the controller 42 of the set top box 40 outputs a video signal and a sound signal of the first channel received by the tuner 44 for Satellite broadcasting, toward the television apparatus 10 via the video/sound signal line 72. Further, in response to the aforesaid video output request command, the controller 32 of the AV amplifier 30 performs processing for outputting, to the television apparatus 10, the video signal and the sound signal inputted from the set top box 40. Further, in addition to outputting the video signal and the sound signal as described above, the controller 42 of the set top box 40 transmits a video output notification command notifying that the video signal and the sound signal have been outputted, to all the AV apparatuses 10, 30, 50, 60 via the control signal lines 76.

Next, the controller 20 of the television apparatus 10 controls the signal processor 14 so that a video signal and a sound signal reproduced by the display 17 and the speaker are changed. To describe in more detail, the controller 20 of the television apparatus 10 changes an input terminal of video signals and sound signals from an input terminal connected to the tuner 12 of the television apparatus 10 to an input terminal connected to the set top box 40 via the HDMI cable 70. As a result of a series of such processes, video displayed on the display 17 of the television apparatus 10 is changed from video received by the tuner 12 of the television apparatus 10 to video received by the tuner 44 of the set top box 40.

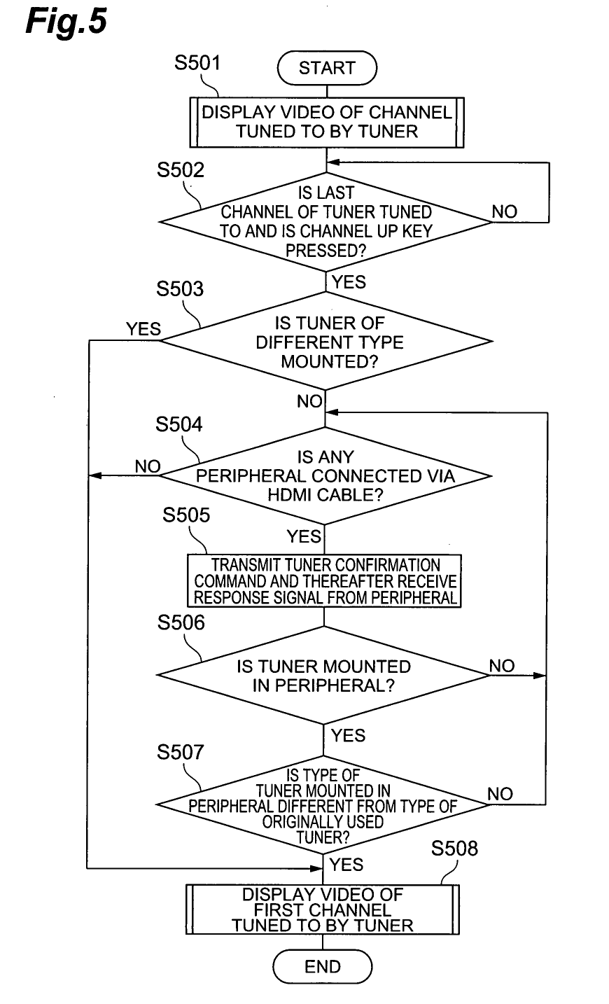

Next, second display change processing executed in the video display system of this embodiment will be described. The second display change processing is executed when a user presses the channel up key of the remote controller 27 for the television apparatus 10. FIG. 5 shows a flowchart of processes executed by the controller 20 of the television apparatus 10 in the second display change processing. The display change processing described here is realized by the controller 20 of the television apparatus 10 executing a program.

At S501, the controller 20 of the television apparatus 10 displays on the display 17 video received by the tuner 12, 44, or 64 mounted in the television apparatus 10 or either of the peripherals 40, 60 (S501). For convenience of description, it is assumed in the following description that subsequent processes are executed in a state where video of a terrestrial digital broadcast received by the tuner 12 mounted in the television apparatus 10 is displayed on the display 17. However, the subsequent processes may be executed in a state where video received by the tuner 44 or 64 of the peripheral 40 or 60 is displayed on the display 17.

At S502, the controller 20 of the television apparatus 10 determines whether or not a tuner change condition under which tuner change should be performed is satisfied. Here, the tuner change condition is a condition that “the last channel (that is, a channel with the largest number) among channels tunable by the tuner is tuned to and the channel up key is operated”. When determining at S502 that the tuner change condition is satisfied, the controller 20 of the television apparatus 10 proceeds to a process at S503.

At S503, the controller 20 of the television apparatus 10 determines whether or not a tuner of a different type is mounted in the television apparatus 10 (the peripheral 40 or 60 if video received by the peripheral 40 or 60 is displayed at S501). When determining at S503 that a tuner of a different type is mounted in the television apparatus 10, the controller 20 of the television apparatus 10 proceeds to a process at S508, and performs control so that the first channel received by this tuner is tuned to and a video signal of the tuned channel is displayed on the display 17. On the other hand, when determining at S503 that a tuner of a different type is not mounted in the television apparatus 10, the controller 20 of the television apparatus 10 proceeds to a process at S504.

At S504, the controller 20 of the television apparatus 10 checks whether or not any peripheral is connected via the HDMI cable 70. The controller 20 of the television apparatus 10 is set to check the presence/absence of a peripheral and a physical address of the peripheral when the television apparatus 10 is activated, and stores information on the presence/absence and physical address of the peripheral after the television apparatus 10 is activated. Therefore, the controller 20 of the television apparatus 10 can check the presence/absence of the peripheral connected via the HDMI cable 70 based on the stored information on the presence/absence of the peripheral. When determining at S504 that no peripheral is connected, the controller 20 of the television apparatus 10 proceeds to the process at S508, and performs control so that the first channel received by the originally used tuner 12 mounted in the television apparatus 10 is tuned to and a video signal of the tuned channel is displayed on the display 17. When determining at S504 that there exists a connected peripheral, the controller 20 of the television apparatus 10 proceeds to a process at S505.

At S505, the controller 20 of the television apparatus 10 transmits a tuner confirmation command for checking whether or not a tuner is mounted in the peripheral. The tuner confirmation command is a control signal not only for inquiry of the presence/absence of a tuner but also for inquiry of the type of the tuner. When receiving the tuner confirmation command from the television apparatus 10, the peripheral reads, from the ROM, the information indicating the presence/absence of a tuner and the type of the tuner, and transmits a response signal including such information to notify the presence/absence of a tuner and the type of the tuner. The information indicating the type of the tuner is information indicating the type of a broadcast received by the tuner, such as, for example, a terrestrial analog broadcast, a terrestrial digital broadcast, a Satellite broadcast, or the like. At S505, when receiving the response signal transmitted from the peripheral, the controller 20 of the television apparatus 10 proceeds to a process at S506.

At S506, the controller 20 of the television apparatus 10 determines whether or not a tuner is mounted in the peripheral, based on the response signal sent from the peripheral. When determining at S506 that a tuner is not mounted in the peripheral, the controller 20 of the television apparatus 10 returns to the process at S504 to check whether or not any other peripheral is connected via the HDMI cable 70. On the other hand, when determining at S506 that a tuner is mounted in the peripheral, the controller 20 of the television apparatus 10 proceeds to a process at S507.

At S507, the controller 20 of the television apparatus 10 determines whether or not the tuner mounted in the peripheral is of a unique type. That is, the controller 20 of the television apparatus 10 determines whether or not the type of the tuner of the peripheral is different from the type of the tuner 12 of the television apparatus 10 (the television apparatus 10 and the peripheral 40 or 60 whose tuners have already been used for video display, if video received by the peripheral 40 or 60 is displayed at S501). When determining at S507 that the type of the tuner of the peripheral is different from the type of the tuner 12 of the television apparatus 10, the controller 20 of the television apparatus 10 proceeds to the process at S508, and performs control so that the first channel received by the tuner of the peripheral is tuned to and video of the tuned channel is displayed on the display 17. On the other hand, when determining at S507 that the type of the tuner of the peripheral is not different from the type of the tuner 12 of the television apparatus 10, the controller 20 of the television apparatus 10 returns to the process at S504 to check whether or not any other peripheral is connected via the HDMI cable 70.

According to the above-described second display change processing, when a user presses the channel up key provided in the remote controller 27 for the television apparatus 10 a plurality of times, video displayed on the display 17 of the television apparatus 10 is changed from video received by the tuner 12 of the television apparatus 10 to video received by the tuner 44 or 64 of the peripheral 40 or 60, at a timing when the tuner change condition is satisfied. To describe in more detail, by pressing the channel up key a plurality of times, the user can change video displayed on the display 17 of the television apparatus 10 from video of the last channel received by the tuner 12 of the television apparatus 10 to video of the first channel received by the tuner 44 of the set top box 40. By further pressing the channel up key, the user can change video displayed on the display 17 of the television apparatus 10 from video of the last channel received by the tuner 44 of the set top box 40 to video of the first channel received by the tuner 64 of the HDD recorder 60. By further pressing the channel up key, the user can change video of the last channel received by the tuner 64 of the HDD recorder 60 to video of the first channel received by the originally used tuner 12 of the television apparatus 10.

In particular, according to the above-described second display change processing, when video displayed on the display 17 of the television apparatus 10 is to be changed, it is determined whether or not the type of the tuner to be used next for video display is different from the type of the tuner already used for video display (S507), and only when it is determined that the types of the tuners are different, the video is changed. Therefore, the display 17 does not redundantly display video of the broadcast of the same type, which can make the video display system easier to handle for a user.

In the process at S502 in the above-described second display change processing, the tuner change condition is “the last channel is tuned to by the tuner and the channel up key is operated”, but the display change processing is also executed in the same manner under the condition that “the first channel (that is, a channel with the smallest number) is tuned to by the tuner and the channel down key is operated”. In a case where this tuner change condition is adopted, the controller 20 of the television apparatus 10 performs control at S508 so that the last channel received by the tuner is tuned to and video of the tuned channel is displayed on the display 17.

Incidentally, in the above-described second display change processing, it is also suitable to change the display based on a priority sequence given to each tuner type. For example, tuner change may be performed in order of 1. a tuner for terrestrial analog broadcasting, 2. a tuner for terrestrial digital broadcasting, and 3. a tuner for Satellite broadcasting, every time a user presses the channel up key. Such display change processing can be realized by the controller 20 of the television apparatus 10 further determining at S507 whether or not the type of the tuner corresponds to the priority sequence. Executing such display change processing makes it possible to always display videos on the display 17 in the same order, which can make the video display system easier to handle for a user.

In the above-described second display change processing, at the timing when the user presses the channel up key, the controller 20 of the television apparatus 10 transmits the tuner confirmation command to the controller 32, 42, 52, or 62 of the peripheral 30, 40, 50, or 60 to inquire the presence/absence of a tuner and the type of the tuner. However, at another timing, the controller 20 of the television apparatus 10 may transmit the tuner confirmation command to the controllers 32, 42, 52, 62 of the peripherals 30, 40 50, 60 to inquire the presence/absence of a tuner and the type of the tuner. For example, at the activation timing of the television apparatus 10, the controller 20 of the television apparatus 10 may transmit the tuner confirmation command to the controllers 32, 42, 52, 62 of the peripherals 30, 40, 50, 60 to inquire the presence/absence of a tuner and the type of the tuner. By transmitting the tuner confirmation command at such a timing, it is possible to generate table data including information on the presence/absence of tuners and the type of the tuners in advance, so that the above-described display change processing can be executed speedily.

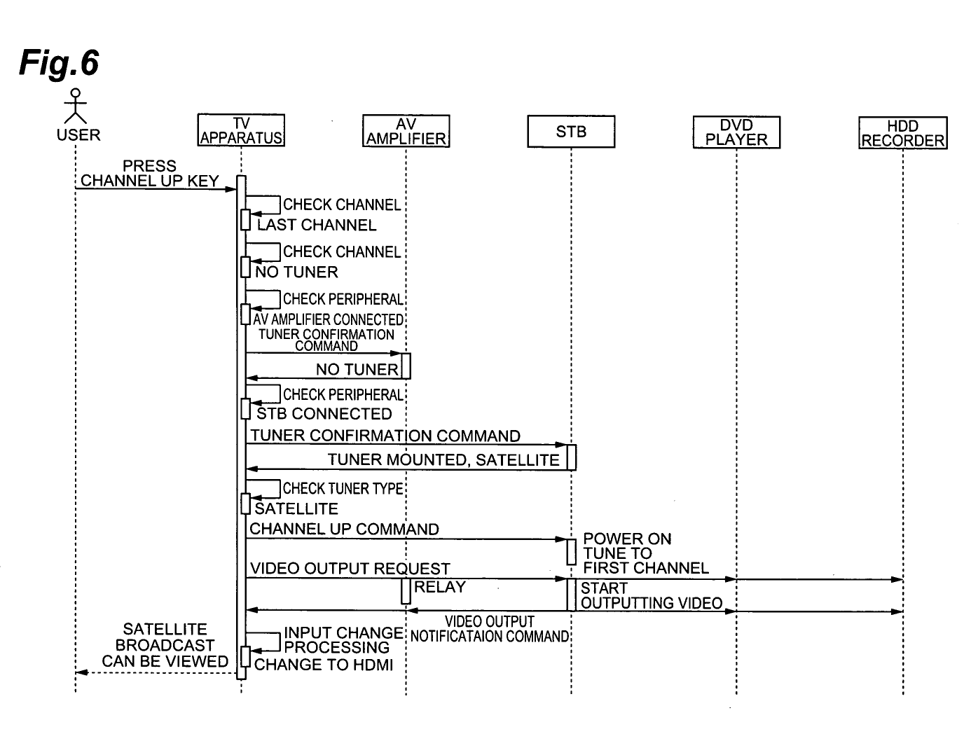

Next, the operations of the television apparatus 10 and its peripherals 30, 40, 50, 60 when the display change processing of this embodiment is executed will be described with reference to a sequence chart shown in FIG. 6. The sequence chart in FIG. 6 shows the operations of the television apparatus 10 and its peripherals 30, 40, 50, 60 together with control signals exchanged between the television apparatus 10 and its peripherals 30, 40, 50, 60.

When a user presses the channel up key of the remote controller 27 for the television apparatus 10, the controller 20 of the television apparatus 10 recognizes that the channel up key has been pressed by the user. Then, the controller 20 of the television apparatus 10 checks a channel currently displayed on the display 17. When it is determined here that the last channel is tuned to by the tuner 12, the tuner change condition is satisfied, and therefore, the controller 20 of the television apparatus 10 subsequently checks whether or not a tuner of a different type is mounted in the television apparatus 10. However, in this embodiment, since only the tuner 12 for terrestrial digital broadcasting is mounted in the television apparatus 10, the controller 20 of the television apparatus 10 determines that a tuner of a different type is not mounted.

Next, the controller 20 of the television apparatus 10 checks whether or not any peripheral is connected via the HDMI cable 70. In this embodiment, since the AV amplifier 30, the set top box 40, the DVD player 50, the HDD recorder 60, and so on are connected, the controller 20 of the television apparatus 10 first recognizes the presence of the AV amplifier 30 whose physical address is the smallest among these peripherals. Then, the controller 20 of the television apparatus 10 transmits a tuner confirmation command for confirming the presence/absence of a tuner and the type of the tuner, to the AV amplifier 30 via the control signal line 76. No tuner is mounted in the AV amplifier 30, and therefore, in response to the tuner confirmation command, the controller 32 of the AV amplifier 30 transmits a response signal indicating that no tuner is mounted, to the television apparatus 10 via the control signal line 76. When receiving the response signal, the controller 20 of the television apparatus 10 recognizes that no tuner is mounted in the AV amplifier 30.

Next, the controller 20 of the television apparatus 10 checks whether or not any other peripheral is connected via the HDMI cable 70. Secondly, the controller 20 of the television apparatus 10 confirms the presence of the set top box 40 whose physical address is the second smallest among the peripherals. Then, the controller 20 of the television apparatus 10 transmits a tuner confirmation command for confirming the presence/absence of a tuner and the type of the tuner, to the set top box 40 via the control signal line 76. The tuner 44 for Satellite broadcasting is mounted in the set top box 40, and therefore, in response to the tuner confirmation command, the controller 42 of the set top box 40 transmits a response signal indicating that the tuner 44 for Satellite broadcasting is mounted, to the television apparatus 10 via the control signal line 76. The controller 20 of the television apparatus 10 checks the type of the tuner 44 mounted in the set top box 40, and recognizes, based on the response signal sent from the set top box 40, that the tuner 44 for Satellite broadcasting is mounted in the set top box 40.

Next, the controller 20 of the television apparatus 10 transmits a channel up command instructing to tune to a channel with the next number, to the set top box 40 via the control signal line 76. In response to the channel up command, the controller 42 of the set top box 40 starts power supply to each part of the set top box 40 and causes the tuner 44 for Satellite broadcasting to tune to the first channel. Next, the controller 20 of the television apparatus 10 transmits a video output request command requesting the output of video, to all the peripherals via the control signal lines 76. In response to the video output request command, the controller 42 of the set top box 40 outputs a video signal and a sound signal of the first channel tuned to by the tuner 44 for Satellite broadcasting, toward the television apparatus 10 via the video/sound signal line 72. Further, in response to the aforesaid video output request command, the controller 32 of the AV amplifier 30 performs processing for outputting the video signal and the sound signal sent from the set top box 40. Further, in addition to outputting the video signal and the sound signal as described above, the controller 42 of the set top box 40 transmits a video output notification command notifying that the video signal and the sound signal have been outputted, to all the AV apparatuses 10, 30, 50, 60 via the control signal lines 76.

Next, the controller 20 of the television apparatus 10 controls the signal processor 14 so that a video signal and a sound signal reproduced by the display 17 and the speaker are changed. To describe in more detail, the controller 20 of the television apparatus 10 changes an input terminal of video signals and sound signals from the input terminal connected to the tuner 12 of the television apparatus 10 to the input terminal connected to the set top box 40 via the HDMI cable 70. As a result of a series of such processes, video displayed on the display 17 of the television apparatus 10 is changed from video received by the tuner 12 mounted in the television apparatus 10 to video received by the tuner 44 mounted in the set top box 40.

### Second Embodiment

Next, a video display system of a second embodiment will be described. The video display system of the second embodiment has the same structure as that of the first embodiment and its processing is different from the processing of the first embodiment. The processing of the video display system of the second embodiment will be roughly described. In the video display system of the second embodiment, channels tunable by the tuners 44, 64 of the peripherals 40, 60 can be registered in correspondence to the keys of the ten-key pad of the remote controller 27 for the television apparatus 10, and by pressing one key of the ten-key pad of the remote controller 27 for the television apparatus 10, it is possible to display on the display 17 video of a channel tuned to by either of the tuners 44, 64 of the peripherals 40, 60.

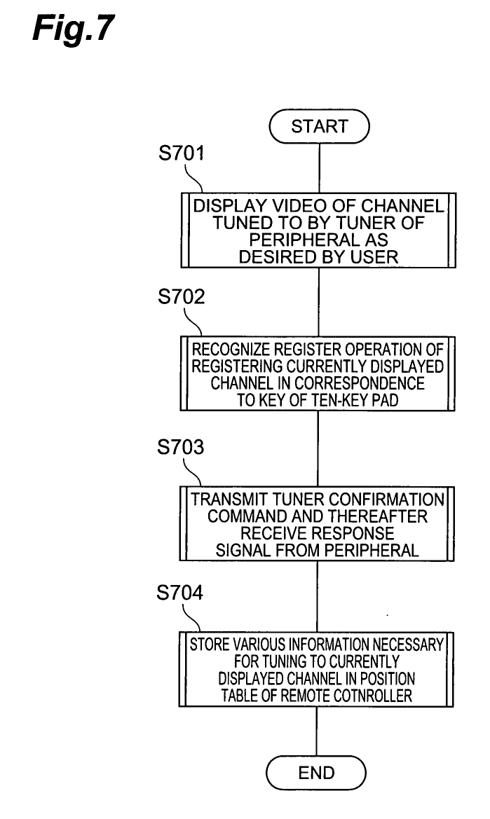

Channel register processing of this embodiment will be described. The channel register processing of this embodiment is executed in order to register the channels tuned to by the tuners 44, 64 of the peripherals 40, 60 in correspondence to the keys of the ten-key pad of the remote controller 27 of the television apparatus 10. FIG. 7 shows a flowchart of processes executed by the controller 20 of the television apparatus 10 in this register processing. The register processing described here is realized by the controller 20 of the television apparatus 10 executing a program.

When a user performs an operation for selecting a channel that the user likes by using a remote controller for the peripheral 40 or 60, the controller 42 or 62 of the peripheral 40 or 60 recognizes the selection operation by the user, and causes the tuner 44 or 64 of the peripheral 40 or 60 to tune to the channel desired by the user. A video signal and a sound signal of the tuned channel are outputted to the television apparatus 10 via the HDMI cable 70. When recognizing that the video signal and the sound signal from the peripheral 40 or 60 have reached, the controller 20 of the television apparatus 10 displays the video signal on the display 17 and outputs the sound signal from the speaker (S701).

At S702, when the user performs a register operation of assigning the currently displayed channel to one key of the ten-key pad by using the remote controller 27 for the television apparatus 10, the controller 20 of the television apparatus 10 recognizes the register operation by the user. Here, to perform the register operation of assigning the currently displayed channel to one key of the ten-key pad, for example, a user keeps pressing, for 3 seconds, one key of the ten-key pad to which the currently displayed channel is to be assigned.

When recognizing the register operation by the user, the controller 20 of the television apparatus 10 transmits, at S703, a tuner confirmation command for confirmation about the tuner, to the peripheral 40 or 60 outputting the video signal and the sound signal. The tuner confirmation command is a control signal not only for inquiry of the type of the tuner but also for inquiry of tuning information of the tuner. When receiving the tuner confirmation command from the television apparatus 10, the peripheral 40 or 60 reads, from the ROM, the information indicating the type of the tuner and the tuning information of the tuner, and transmits a response signal including these pieces of information. When receiving the response signal sent from the peripheral 40 or 60 at S703, the controller 20 of the television apparatus 10 proceeds to a process at S704.

At S704, the controller 20 of the television apparatus 10 stores various information necessary for tuning to the currently displayed channel, in a position table of the remote controller 27 for the television apparatus 10. Here, the various information necessary for tuning to the currently displayed channel includes the physical address of the peripheral, the type information of the tuner mounted in the peripheral, the tuning information of the tuner, and so on. The tuning information of the tuner is information necessary for tuning to the currently displayed channel, and in a case of analog broadcasting, it is information on a frequency of a broadcast wave, and in a case of digital broadcasting, it is transport_sream_id, service_id, and network_id.

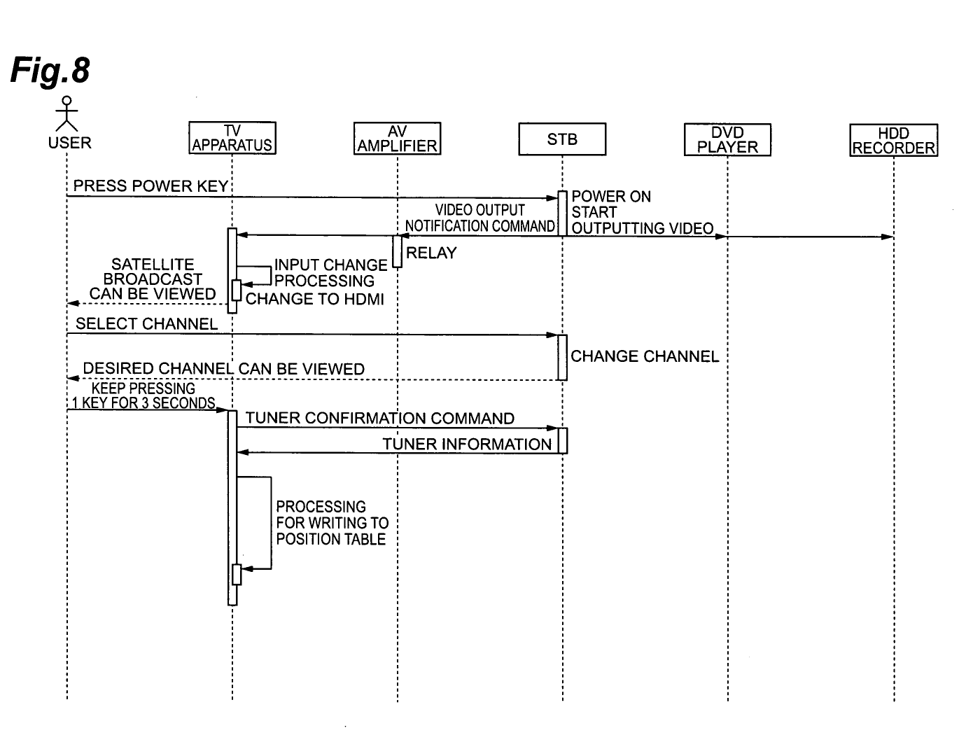

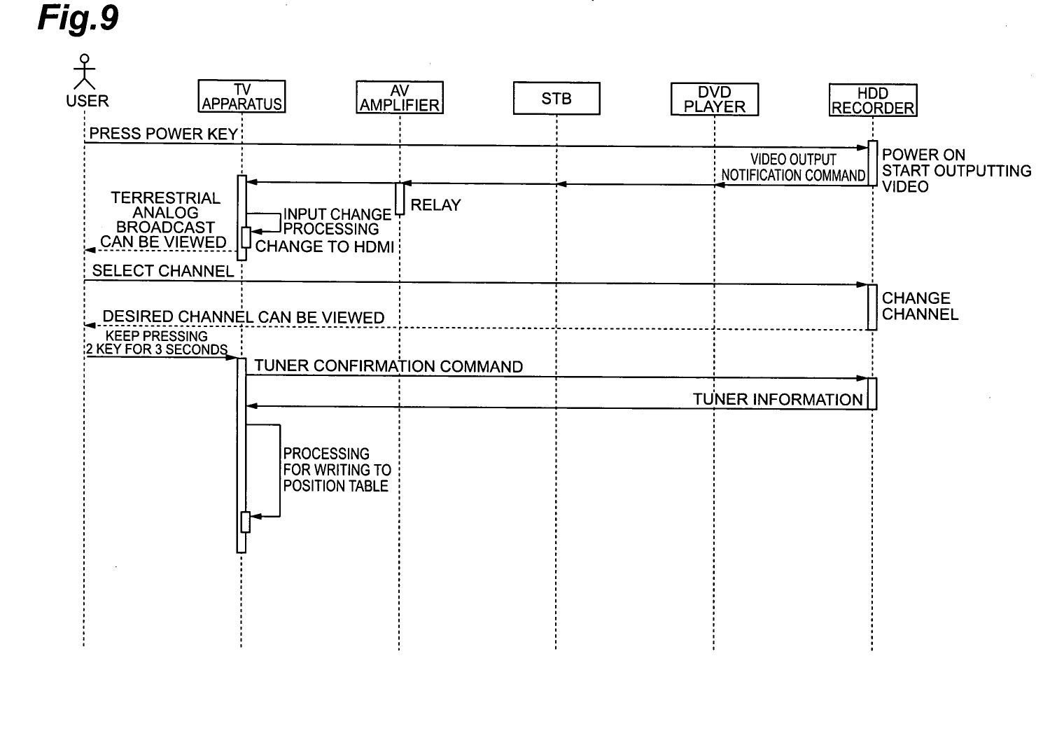

Next, the operations of the television apparatus 10 and its peripherals 30, 40, 50, 60 when the above-described register processing is executed will be described with reference to FIG. 8 and FIG. 9. Sequence charts in FIG. 8 and FIG. 9 show the operations of the television apparatus 10 and its peripherals 30, 40, 50 together with control signals exchanged between the television apparatus 10 and its peripherals 30, 40, 50, 60.

The register processing for registering a currently displayed channel in correspondence to a 1 key will be described with reference to the sequence chart in FIG. 8. When a user presses a power key of the remote controller for the set top box 40, the controller 42 of the set top box 40 recognizes the operation by the user and supplies power to each part of the set top box 40. Then, the controller 42 of the set top box 40 outputs a video signal and a sound signal received by the tuner 44 of the set top box 40 and also transmits a video output notification command notifying that the video signal and the sound signal have been outputted, to all the AV apparatuses 10, 30, 50, 60 via the control signal lines 76.

In response to the aforesaid video output notification command, the controller 32 of the AV amplifier 30 performs processing for outputting, to the television apparatus 10, the video signal and the sound signal inputted from the set top box 40. Further, in response to the aforesaid video output notification command, the controller 20 of the television apparatus 10 controls the signal processor 14 so that a video signal and a sound signal reproduced by the display 17 and the speaker are changed. To describe in more detail, the controller 20 of the television apparatus 10 changes an input terminal of video signals and sound signals from the input terminal connected to the tuner 12 of the television apparatus 10 to the input terminal connected to the set top box 40 via the HDMI cable 70.

When the user performs an operation for selecting a channel by using the remote controller for the set top box 40, in response to the selection operation by the user, the controller 42 of the set top box 40 causes the tuner 44 of the set top box 40 to tune to the channel and to output a video signal and a sound signal of the tuned channel toward the television apparatus 10 via the video/sound signal line 72. As a result of a series of such processes, video displayed on the display 17 of the television apparatus 10 is changed to video of the channel tuned to by the tuner 44 of the peripheral as desired by the user.

When the user keeps pressing the 1 key of the remote controller 27 for the television apparatus 10 for 3 seconds, the controller 20 of the television apparatus 10 recognizes the operation by the user and transmits a tuner confirmation command for confirming the type and the tuning information of the tuner to the set top box 40 via the control signal line 76. The tuner confirmation command is a control signal not only for inquiry of the type of the tuner but also for inquiry of the tuning information of the tuner. When receiving the tuner confirmation command, the controller 42 of the set top box 40 transmits tuner information. Here, the tuner information includes the type information of the tuner and the tuning information of the tuner.

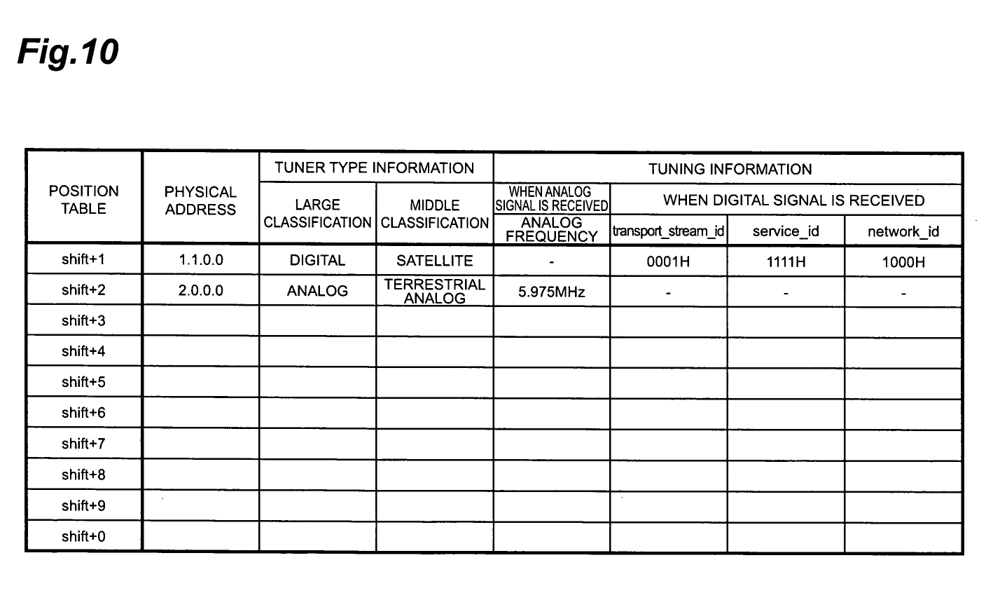

When receiving the tuner information, the controller 20 of the television apparatus 10 registers the physical address of the set top box 40, the type information of the tuner 44, and the tuning information of the tuner 44 in the position table of the remote controller 27 for the television apparatus 10 in correspondence to the 1 key. As a result of the above-described register processing, the channel desired by the user is registered in the position table of the remote controller 27 for the television apparatus 10 in correspondence to the 1 key as shown in FIG. 10. To describe in more detail, in correspondence to position “shift+1”, “1.1.1.0” is registered as the physical address of the set top box 40, large classification “digital” and middle classification “Satellite” are registered as the tuner type, and transport_stream_id “0001H”, service_id “1111H”, and network_id “1000H” are registered as the tuning information of the tuner.

The register processing for registering a currently displayed channel in correspondence to a 2 key will be described with reference to the sequence chart in FIG. 9. When a user presses a power key of a remote controller for the HDD recorder 60, the controller 62 of the HDD recorder 60 recognizes the operation by the user and supplies power to each part of the HDD recorder 60. Then, the controller 62 of the HDD recorder 60 outputs a video signal and a sound signal of a channel tuned to by the tuner 64 mounted in the HDD recorder 60 and transmits a video output notification command notifying that the video signal and the sound signal have been outputted, to all the AV apparatuses 10, 30, 40, 50, via the control signal lines 76.

In response to the aforesaid video output notification command, the controller 20 of the television apparatus 10 controls the signal processor 14 so that a video signal and a sound signal reproduced by the display 17 and the speaker are changed. To describe in more detail, the controller 20 of the television apparatus 10 changes an input terminal of video signals and sound signals from the input terminal connected to the tuner 12 of the television apparatus 10 to an input terminal connected to the HDD recorder 60 via the HDMI cable 70.

When the user performs an operation for selecting a channel by using the remote controller for the HDD recorder 60, in response to the selection operation by the user, the controller 62 of the HDD recorder 60 causes the tuner 64 of the HDD recorder 60 to tune to the channel and to output a video signal and a sound signal of the tuned channel to the television apparatus 10 via the video/sound signal line 72. As a result of a series of such processes, video displayed on the display 17 of the television apparatus 10 is changed to video of the channel tuned to by the tuner 64 of the HDD recorder 60 as desired by the user.

Then, when the user keeps pressing the 2 key of the remote controller 27 for the television apparatus 10 for 3 seconds, the controller 20 of the television apparatus 10 recognizes the operation by the user and transmits a tuner confirmation command for confirming the type and the tuning information of the tuner to the HDD recorder 60 via the control signal line 76. The tuner confirmation command is a control signal not only for inquiry of the type of the tuner but also for inquiry of the tuning information of the tuner. When receiving the tuner confirmation command, the controller 62 of the HDD recorder 60 transmits tuner information. Here, the tuner information includes the type information of the tuner and the tuning information of the tuner.

When receiving the tuner information, the controller 20 of the television apparatus 10 registers the physical address of the HDD recorder 60, the type information of the tuner 64, and the tuning information of the tuner 64 in the position table of the remote controller 27 for the television apparatus 10 in correspondence to the 2 key. As a result of the above-described register processing, the channel desired by the user is registered in the position table of the remote controller 27 for the television apparatus 10 in correspondence to the 2 key as shown in FIG. 10. To describe in more detail, in correspondence to position “shift+2”, “2.0.0.0” is registered as the physical address of the HDD recorder 60, large classification “analog” and middle classification “terrestrial analog” are registered as the tuner type, and an analog frequency “5.975 MHz” is registered as the tuning information of the tuner.

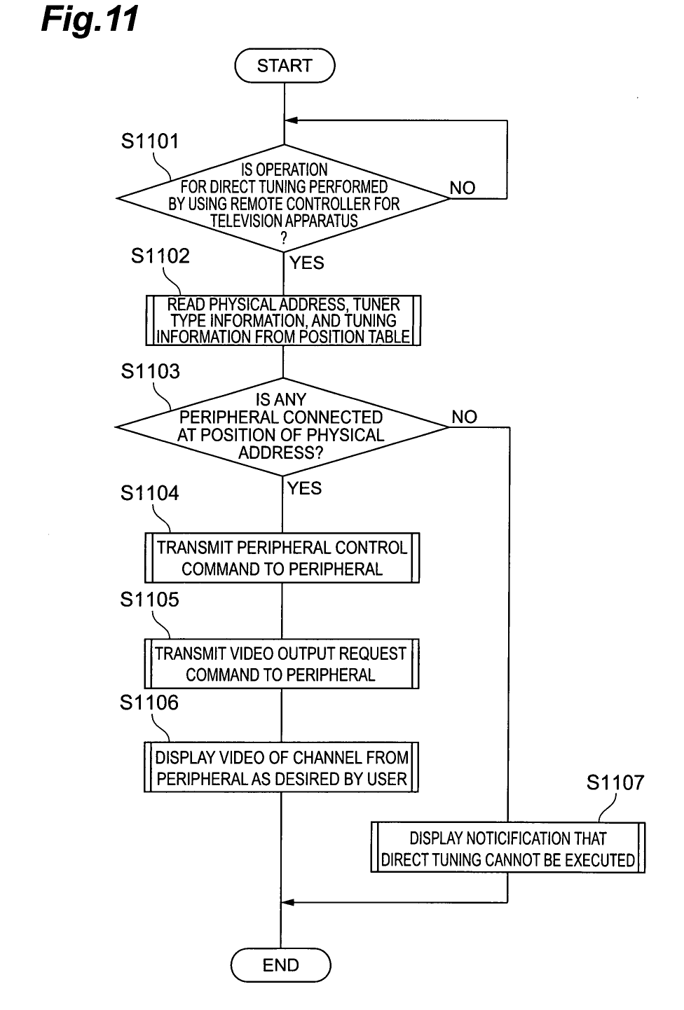

Next, direct tuning processing realized by utilizing the aforesaid position table will be described. Here, the “direct tuning processing” is processing in which, only by a user's simple operation of the remote controller 27 for the television apparatus 10, the tuners 44, 64 of the peripherals 40, 60 are caused to tune to a channel desired by a user and the display 17 of the television apparatus 10 is caused to display video of this channel. FIG. 11 shows a flowchart of the direct tuning processing executed by the controller 20 of the television apparatus 10. The direct tuning processing described here is realized by the controller 20 of the television apparatus 10 executing a program.

At S1101, the controller 20 of the television apparatus 10 determines whether or not a user has performed a specific operation for the direct tuning by using the remote controller 27 for the television apparatus 10. Here, the specific operation for the direct tuning is a user's operation triggering the start of the direct tuning processing. Concretely, it is an operation of a user pressing a shift key and one key of the ten-key pad simultaneously. When determining at S1101 that the specific operation for the direct tuning is performed by the user, the controller 20 of the television apparatus 10 proceeds to a process at S1102.

At S1102, the controller 20 of the television apparatus 10 reads the physical address, the tuner type information, and the tuning information of the peripheral registered in correspondence to the key of the ten-key pad pressed by the user, from the position table stored in the ROM 22. Then, at S1103, the controller 20 of the television apparatus 10 determines whether or not a peripheral exists at a position of this physical address. When determining at S1103 that a peripheral exists, the controller 20 of the television apparatus 10 proceeds to a process at S1104. On the other hand, when determining at S1103 that no peripheral exists, the controller 20 of the television apparatus 10 proceeds to a process at S1107 to display on the display 17 a screen display notifying that the direct tuning cannot be executed.

At S1104, the controller 20 of the television apparatus 10 transmits a peripheral control command to this peripheral via the control signal line 76. Here, the peripheral control command is a control signal including the tuner type information and the tuning information read from the position table, and is a control signal for inquiring whether a tuner of the type specified by the tuner type information exists in the transmission destination peripheral and for causing the tuner of this type to tune to a channel according to the tuning information.

At S1105, the controller 20 of the television apparatus 10 transmits a video output request command to the peripheral via the control signal line 76, thereby causing the peripheral to output a video signal and a sound signal. Then, at S1106, the controller 20 of the television apparatus 10 receives the video signal and the sound signal outputted from the peripheral and causes the display 17 to display video of the channel desired by the user.

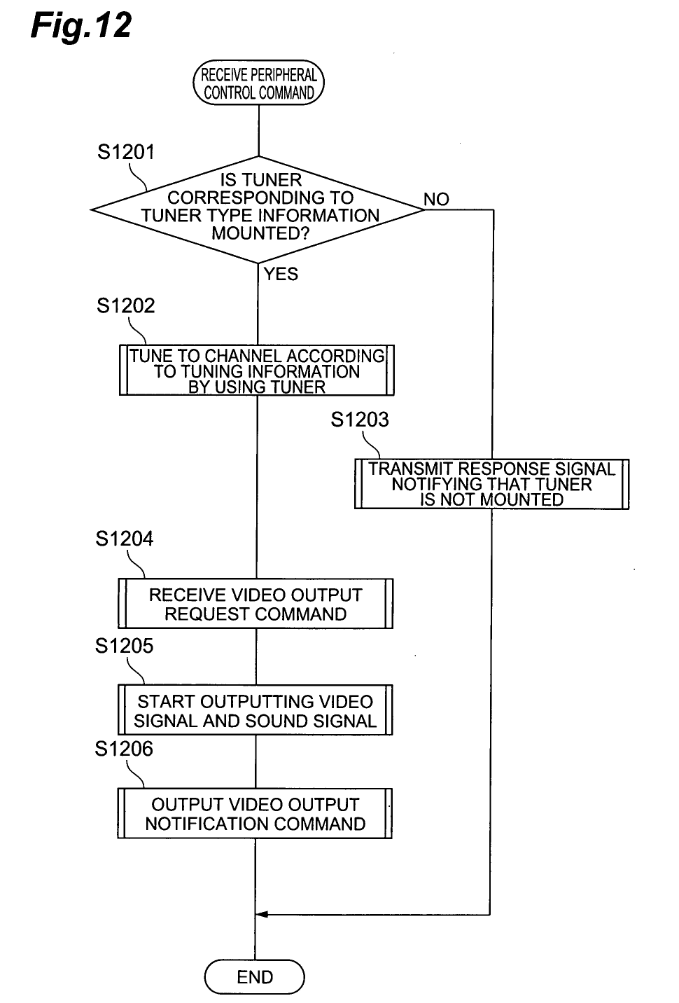

Next, processing that the controller of the peripheral executes when receiving the aforesaid peripheral control command will be described. When receiving the peripheral control command from the television apparatus 10, the controller of the peripheral starts processing in a flowchart in FIG. 12. The processing described here is realized by the controller of the peripheral executing a program.

When receiving the peripheral control command from the television apparatus 10, the controller of the peripheral, at Step S1201, supplies power to each part of the peripheral and determines whether or not a tuner of the type specified by the tuner type information included in the peripheral control command is mounted in this peripheral. When determining at S1201 that the tuner is mounted, the controller of the peripheral proceeds to a process at S1202 and causes the tuner to tune to a channel according to the tuning information. On the other hand, when determining at S1201 that the tuner is not mounted, the controller of the peripheral proceeds to a process at S1203 and transmits, to the television apparatus 10, a response signal notifying that a tuner of this type is not mounted and thereafter finishes the processing.

At S1204, when further receiving [symbol] video output request command from the television apparatus 10, the controller of the peripheral proceeds to a process at S1205, and in response to the video output request command, the controller of the peripheral outputs a video signal and a sound signal of the channel tuned to by the tuner, to the television apparatus 10 via the video/sound signal line 72. Then, at S1206, the controller of the peripheral transmits a video output notification command notifying that the video signal and the sound signal have been outputted, to all the AV apparatuses via the control signal lines 76.

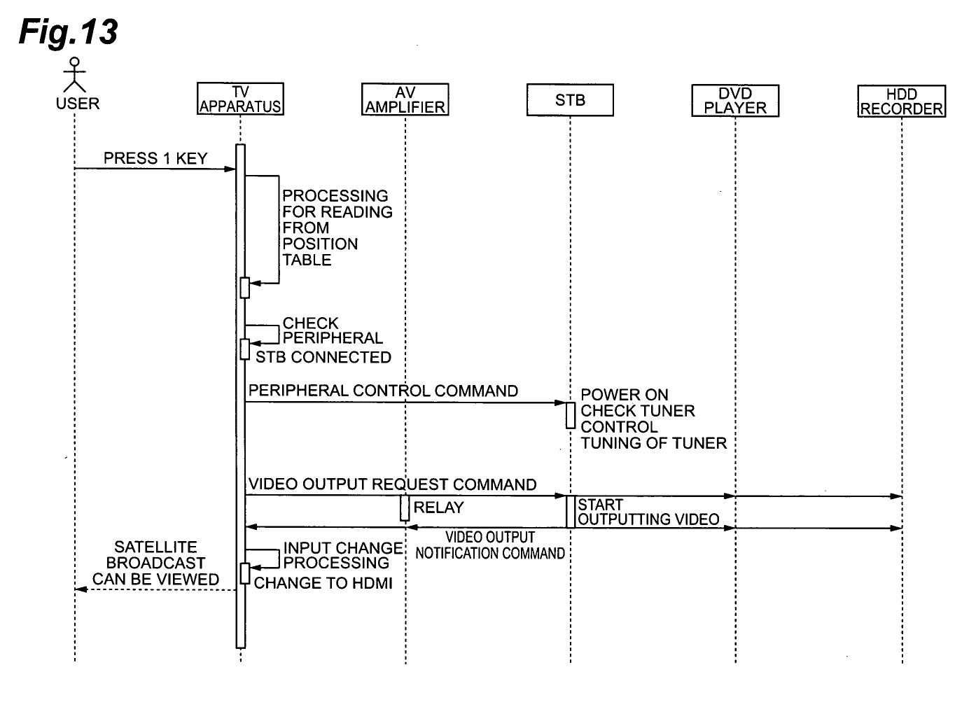

Next, with reference to a sequence chart in FIG. 13, a description will be given of the operations of the television apparatus 10 and its peripherals 30, 40, 50, 60 when the direct tuning processing is executed in response to a user's operation of simultaneously pressing the shift key and the 1 key of the remote controller 27 for the television apparatus 10.

When the user simultaneously presses the shift key and the 1 key of the remote controller 27 for the television apparatus 10, the controller 20 of the television apparatus 10 recognizes the user's specific operation for direct tuning and reads the information which is registered in the position table shown in FIG. 10 in correspondence to the “1 key”. Here, from the position table, the controller 20 of the television apparatus 10 reads the physical address “1.1.1.0”, the tuner type information “digital” and “Satellite”, and the tuning information “transport_stream_id”, “service id”, and “network id”.

Next, the controller 20 of the television apparatus 10 performs processing for confirming whether or not a peripheral exists at the position of the physical address “1.1.1.0” read from the position table. By this processing, the controller 20 of the television apparatus 10 recognizes that the set top box 40 is connected at the position of the physical address.

Next, the controller 20 of the television apparatus 10 transmits a peripheral control command including the tuner type information and the tuning information read from the position table, to the set top box 40 via the control signal line 76. When receiving the peripheral control command, the controller 42 of the set top box 40 supplies power to each part of the set top box 40 and thereafter confirms that the tuner 44 of the type specified by the tuner type information is mounted in the set top box 40 and causes the tuner 44 to tune to a channel according to the tuning information.

Next, the controller 20 of the television apparatus 10 transmits a video output request command for requesting the set top box 40 to output a video signal and a sound signal, to the set top box 40 via the control signal line 76. When receiving the video output request command signal, the controller 42 of the set top box 40 starts outputting the video signal and the sound signal, and also outputs a video output notification command notifying that the output of the video signal and the sound signal has been started. Further, when receiving the video output request command, the AV amplifier 30 outputs, to the television apparatus 10, the video signal and the sound signal inputted from the set top box 40.

Next, when receiving the video output notification command from the set top box 40, the controller 20 of the television apparatus 10 controls the signal processor 14 so that a video signal and a sound signal reproduced by the display 17 and the speaker 14 are changed. To describe in more detail, the controller 20 of the television apparatus 10 changes an input terminal of video signals and sound signals from the input terminal connected to the tuner 12 of the television apparatus 10 to the input terminal connected to the set top box 40 via the HDMI cable 70. As a result, it is possible to display video of the Satellite broadcasting channel desired by the user on the display 17 of the television apparatus 10, so that the user can view a program of the Satellite broadcasting.

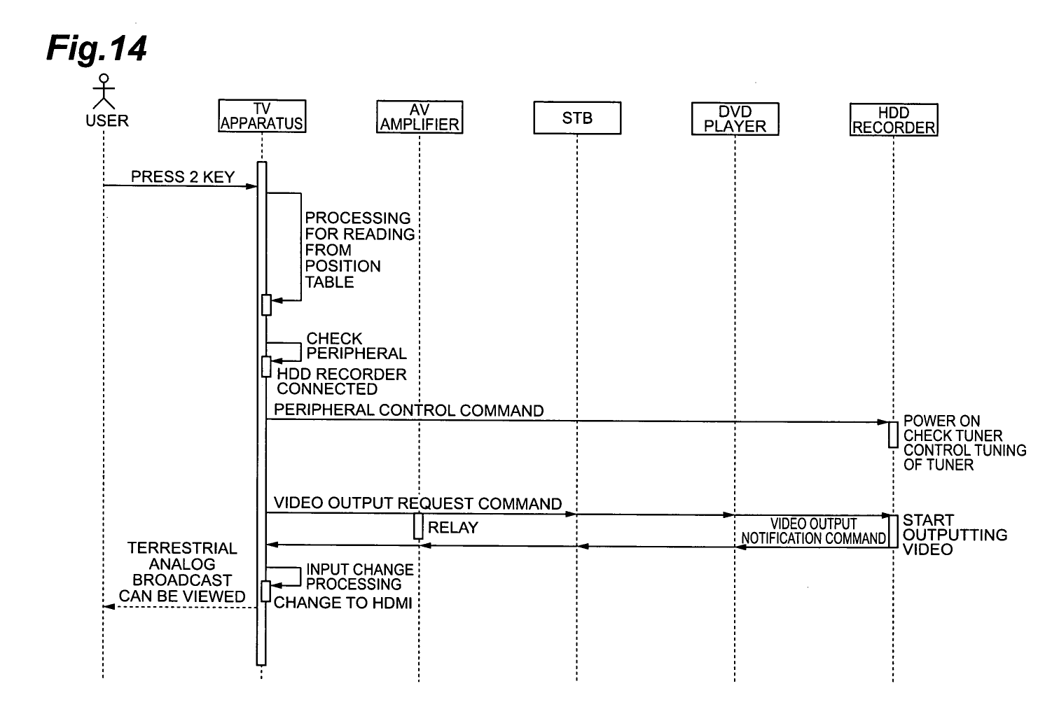

Next, with reference to a sequence chart in FIG. 14, a description will be given of the operations of the television apparatus 10 and its peripherals 30, 40, 50, 60 when the direct tuning processing is executed in response to a user's operation of simultaneously pressing the shift key and the 2 key of the remote controller 27 for the television apparatus 10.

When the user simultaneously presses the shift key and the 2 key of the remote controller 27 for the television apparatus 10, the controller 20 of the television apparatus 10 recognizes the user's specific operation for direct tuning and reads the information which is registered in the position table shown in FIG. 10 in correspondence to the “2 key”. Here, from the position table, the controller 20 of the television apparatus 10 reads the physical address “2.0.0.0”, the tuner type information “analog” and “terrestrial analog”, and the tuning information “5.975 MHz”.

Next, the controller 20 of the television apparatus 10 performs processing for confirming whether or not a peripheral exists at the position of the physical address “2.0.0.0” read from the position table. By this processing, the controller 20 of the television apparatus 10 recognizes that the HDD recorder 60 is connected at the position of the physical address.

Next, the controller 20 of the television apparatus 10 transmits a peripheral control command including the tuner type information and the tuning information read from the position table, to the HDD recorder 60 via the control signal line 76. When receiving the peripheral control command, the controller 62 of the HDD recorder 60 supplies power to each part of the HDD recorder 60 and thereafter confirms that the tuner 64 of the type specified by the tuner type information is mounted in the HDD recorder 60 and causes the tuner 64 to tune to a channel according to the tuning information.

Next, the controller 20 of the television apparatus 10 transmits a video output request command for requesting the HDD recorder 60 to output a video signal and a sound signal, to the HDD recorder 60 via the control signal line 76. When receiving the video output request command signal, the controller 62 of the HDD recorder 60 starts outputting the video signal and the sound signal, and also outputs a video output notification command notifying that the output of the video signal and the sound signal has been started

Next, when receiving the video output notification command from the HDD recorder 60, the controller 20 of the television apparatus 10 controls the signal processor 14 so that a video signal and a sound signal reproduced by the display 17 and the speaker 14 are changed. To describe in more detail, the controller 20 of the television apparatus 10 changes an input terminal of video signals and sound signals from the input terminal connected to the tuner 12 of the television apparatus 10 to the input terminal connected to the HDD recorder 60 via the HDMI cable 70. As a result, it is possible to display video of the terrestrial analog broadcasting channel desired by the user on the display 17 of the television apparatus 10, so that the user can view a program of the terrestrial analog broadcasting.

According to the above-described direct tuning processing, only by performing a simple specific operation for direct tuning by using the remote controller 27 for the television apparatus 10, a user can cause the tuner of the peripheral to tune to the channel desired by the user and cause the display 17 of the television apparatus 10 to display video of this channel. In particular, according to the above-described direct tuning processing, since the tuner used for tuning in the peripheral is decided based on the tuner type information included in the peripheral control command, the user can view video of the channel tuned to by the tuner of a desired type.

According to the above-described direct tuning processing of the embodiment, the physical addresses for specifying the positions of the peripherals are registered in the position table, and the controller 20 of the television apparatus 10 transmits the peripheral control command to the peripheral connected at the position specified by the physical address. However, according to direct tuning processing of another embodiment, instead of registering the physical addresses for specifying the positions of the peripherals in the position table, the controller 20 of the television apparatus 10 may transmit the peripheral control command to all the peripherals connected via the HDMI cables 70. In this case, when receiving the peripheral control command, the controllers of the peripherals check whether or not a tuner of the type specified by the tuner type command included in the peripheral control command is mounted therein, and when the tuner of this type is mounted, this tuner is caused to tune to a channel according to the tuning information.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display system receiving a broadcast video signal to perform display according to the video signal, the system comprising:
a main apparatus including at least a display configured to display video according to the video signal and a controller configured to control an operation of said main apparatus;
one or a plurality of sub apparatuses each including at least a tuner configured to receive a broadcast video signal and a controller configured to control an operation of said sub apparatus by transmitting/receiving a control signal to/from said main apparatus; and
a video signal line and a control signal line disposed between said main apparatus and said sub apparatus, said video signal line being for transmission of the video signal from said sub apparatus to said main apparatus and said control signal line being for transmission of the control signal between said main apparatus and said sub apparatus, wherein:
the controller of said main apparatus is configured to transmit the control signal for inquiry of a type of the tuner of said sub apparatus, to said sub apparatus via said control signal line; and
the controller of said sub apparatus is configured to execute processing corresponding to the control signal when receiving the control signal from said main apparatus.

2. The video display system according to claim 1, wherein, as the processing corresponding to the control signal, the controller of said sub apparatus is configured to transmit a response signal including type information of the tuner of said sub apparatus to said main apparatus via said control signal line when receiving the control signal from said main apparatus.

3. The video display system according to claim 2, wherein,
the controller of said main apparatus is configured to change a video signal displayed on the display from a video signal received by a tuner different in type from the tuner of said sub apparatus to a video signal received by the tuner of the unique type of said sub apparatus
when the controller of said main apparatus determines that a specific operation for changing a broadcast channel is performed by a user and determines that the tuner of said sub apparatus is of a unique type, based on the type information of the tuner included in the response signal transmitted from said sub apparatus.

4. The video display system according to claim 3, wherein the specific operation for changing the broadcast channel is at least one of a channel-up operation performed in a state where video of a broadcast channel with the largest number is displayed on the display and a channel-down operation performed in a state where video of a broadcast channel with the smallest number is displayed on the display.

5. The video display system according to claim 3, wherein the specific operation for changing the broadcast channel is an operation for changing a tuner type.

6. The video display system according to claim 1, wherein:
the control signal transmitted from the controller of said main apparatus includes tuner type information specifying a tuner type and is a signal for inquiring whether or not the type of the tuner of said sub apparatus is the type specified by the tuner type information; and
as the processing corresponding to the control signal, the controller of said sub apparatus is configured to output a video signal received by using the tuner of the type specified by the tuner type information, to said main apparatus via said video signal line when the own sub apparatus includes the tuner of the type specified by the tuner type information.

7. The video display system according to claim 6, wherein:
the control signal transmitted from the controller of said main apparatus is a signal including broadcast channel information specifying a broadcast channel; and
as the processing corresponding to the control signal, the controller of said sub apparatus is configured to output a video signal of the broadcast channel specified by the broadcast channel information out of video signals received by the tuner of the type specified by the tuner type information, to said main apparatus via said video signal line.

8. The video display system according to claim 6, wherein:
the controller of said main apparatus is configured to have data in which the tuner type information is registered in correspondence to specific operations by a user; and
the controller of said main apparatus is configured to transmit a control signal including the tuner type information registered in correspondence to the specific operation performed by the user, to said sub apparatus via said control signal line when one of the specific operations is performed by the user.

9. The video display system according to claim 8, wherein the specific operation is an operation to a button provided in a remote controller for said main apparatus.

10. The video display system according to claim 1, wherein said video signal line and said control signal line conform to a HDMI standard.

11. The video display system according to claim 2, wherein the tuner type information is information specifying one of a tuner receiving a terrestrial broadcast, a tuner receiving a BS broadcast, and a tuner receiving a CS broadcast.

12. A main apparatus of a video display system performing display according to a broadcast video signal,
the main apparatus being connected to a video signal line for transmission of the video signal and to a control signal line for transmission of a control signal, and the main apparatus comprising at least:
a display configured to display video according the video signal transmitted from a sub apparatus via the video signal line; and
a controller configured to control an operation of the main apparatus and transmitting/receiving the control signal to/from the sub apparatus via the control signal line,
wherein said controller is configured to transmit the control signal for inquiry of a type of a tuner included in the sub apparatus, to the sub apparatus via the control signal line.

13. A sub apparatus of a video display system performing display according to a broadcast video signal,
the sub apparatus being connected to a video signal line for transmission of the video signal and to a control signal line for transmission of a control signal, and
the sub apparatus comprising at least:
a tuner configured to receive the broadcast video signal; and
a controller configured to control an operation of the sub apparatus and transmitting/receiving the control signal to/from a main apparatus via the control signal line,
wherein, said controller is configured to execute processing corresponding to the control signal when receiving the control signal for inquiry of a type of said tuner included in the sub apparatus.
